(19) United States
(12) Patent Application Publication
(10) Pub. No.: US 2025/0207275 A1
(43) Pub. Date: Jun. 26, 2025

(54) CATALYSTS EMBEDDED WITH METAL NANOCLUSTERS AND MANUFACTURING METHOD THEREOF

(71) Applicant: UIF (University Industry Foundation), Yonsei University, Seoul (KR)

(72) Inventors: Seong-Ju HWANG, Seoul (KR); So Yeon YUN, Seoul (KR)

(73) Assignee: UIF (University Industry Foundation), Yonsei University, Seoul (KR)

(21) Appl. No.: 18/968,313

(22) Filed: Dec. 4, 2024

(30) Foreign Application Priority Data
Dec. 26, 2023 (KR) 10-2023-0191917

(51) Int. Cl. C25B 11/067; C25B 11/031; C25B 11/081

(52) U.S. Cl. CPC C25B 11/067; C25B 11/031; C25B 11/081

(57) ABSTRACT

According to the present invention, there is provided a method of manufacturing a metal and metal nitride using a single-step nitridation-exsolution synthetic method, including synthesizing metal-substituted metal oxide nanoparticles (S100); synthesizing metal-substituted metal oxide nanowires through hydrothermal synthesis of the metal-substituted metal oxide nanoparticles (S200); and obtaining a metal nitride and exsolved metal through ammonia treatment of the metal-substituted metal oxide nanowires (S300).

### CROSS REFERENCE TO RELATED APPLICATION

This application claims priority to and the benefit of Korean Patent Application No. 10-2023-0191917, filed on Dec. 26, 2023, the disclosure of which is incorporated herein by reference in its entirety.

### BACKGROUND

The present invention relates to a catalyst incorporating metal nanoclusters and a method of manufacturing the same, and more particularly, to a method of manufacturing a metal and metal nitride using a single-step nitridation-exsolution synthetic method.

As the global population has increased, the use of fossil fuels has continued to rise. These fossil fuels emit substances that adversely affect global warming, such as carbon dioxide, and there are concerns about the depletion of reserves. As a result, research has continued on alternative energy sources. Accordingly, hydrogen, which has high energy density and is environmentally friendly, has been introduced as a substitute for fossil fuels, and as the electrochemical catalyst materials used in hydrogen production, platinum is mainly used, but due to its low energy efficiency and high cost, there is a need to develop easily obtainable and highly active electrochemical catalysts that can replace platinum.

Accordingly, metal nanoclusters have recently attracted significant attention as a new type of catalysts with high activity and selectivity. Metal nanoclusters are aggregates of monodisperse metal particles with a diameter smaller than 10 nm (100 Å). Due to their unique properties, which lie between those of bulk materials and single particles, metal nanoclusters are applied in various applications such as quantum dots, quantum computing and devices, chemical sensors, light-emitting diodes, “ferrofluid” for cell separation, industrial lithography, and photochemical patterning for flat panel displays. In particular, metal nanoclusters have garnered considerable interest in catalyst research and development. Recent studies have demonstrated that metal nanoclusters serve as highly effective catalysts, enabling enhanced selectivity beyond the limitations of conventional catalysts.

However, despite their advantages, metal nanoclusters have a drawback of poor durability due to severe aggregation, which occurs as a result of increased surface energy during catalytic reactions. Metal nanoclusters exhibit catalytic activity by utilizing their unique properties, which lie between bulk particles and single particles. However, this stabilization issue caused by aggregation hinders the utilization of metal nanoclusters as catalysts. To overcome these drawbacks, core-shell particle synthesis methods are widely used to enhance the stability of metal nanoclusters. But these encapsulation methods are relatively complex. Additionally, conventional synthesis techniques, including chemical vapor deposition, co-precipitation, and impregnation, are commonly used to produce metal nanoclusters, but these methods have limitations in precisely controlling the interaction between the metal nanoclusters and their support materials.

Meanwhile, the exsolution method involves heat-treating multi-metal oxides containing transition metals in a reducing atmosphere, which induces the migration of metal ions to the surface of a solid substrate while simultaneously forming zero-valent metal nanoclusters on the surface. Some of the exsolved metal nanoclusters are embedded within the solid substrate, resulting in stronger interactions with the substrate compared to conventional methods. Although these advantages, most of exsolution-based researches have focused on the application of sensor rather than that of electrocatalyst. This is because catalytic performance is reduced due to the low conductivity of metal oxide supports, which is detrimental to the electrocatalytic performance of immobilized metal nanocluster.

Prior Art: Korean Intellectual Property Office Registered Patent Publication No. 10-2489090 (published on Jan. 16, 2023)

### SUMMARY

The present invention is directed to improving the performance and stability of a catalyst for the hydrogen evolution reaction utilizing metal nanoclusters.

The present invention is also directed to manufacturing an electrocatalyst with an efficient synthesis strategy.

According to an aspect of the present invention, there is provided a method of manufacturing a metal and metal nitride using a single-step nitridation-exsolution synthetic method, including synthesizing metal-substituted metal oxide nanoparticles (S100); synthesizing metal-substituted metal oxide nanowires through hydrothermal synthesis of the metal-substituted metal oxide nanoparticles (S200); and obtaining a metal nitride and exsolved metal through ammonia treatment of the metal-substituted metal oxide nanowires (S300).

According to another aspect of the present invention, there is provided a metal and metal nitride manufactured by the above manufacturing method, using a single-step nitridation-exsolution synthetic method.

According to the present invention, it is possible to synthesize a catalyst in which noble metal nanoclusters are strongly fixed to a porous nitride support through the development of a single-step nitridation-exsolution synthetic method.

In addition, according to the present invention, since additional processes and lengthy separation steps are not required in synthesizing these materials, time and costs are saved, which is economical.

Additionally, according to the present invention, it is expected that many follow-up studies will be generated by using various materials as precursors, such as conductive metal nitrides and oxides with various metal substitutions, in addition to inorganic matrices.

### BRIEF DESCRIPTION OF THE DRAWINGS

FIG. 1 shows X-ray diffraction patterns of metal-substituted materials according to an embodiment of the present invention;

FIG. 2 shows X-ray diffraction patterns of ammonia-treated materials according to an embodiment of the present invention;

FIG. 3 shows scanning electron micrographs of metal-substituted materials and ammonia- treated materials according to an embodiment of the present invention;

FIG. 4 shows transmission electron micrographs of ammonia-treated materials according to an embodiment of the present invention;

FIG. 5 shows scanning transmission electron micrographs and elemental mapping of ammonia-treated RTN20 according to an embodiment of the present invention;

FIG. 6 shows (a) X-ray absorption near edge structure (XANES) and (b) extended X-ray absorption fine structure (EXAFS) of materials synthesized according to an embodiment of the present invention; and

FIG. 7 shows hydrogen evolution reaction (HER) activity data of materials synthesized according to an embodiment of the present invention.

### DETAILED DESCRIPTION

Hereinafter, the present invention will be described in detail.

The terms used in this application are merely used to describe specific embodiments and are not intended to limit the present invention. Unless otherwise defined, all terms, including technical and scientific terms, used herein have the same meaning as commonly understood by a person of ordinary skill in the art to which the present invention pertains.

According to an aspect of the present invention, there is provided a method of manufacturing a metal and metal nitride using a single-step nitridation-exsolution synthetic method, including synthesizing metal-substituted metal oxide nanoparticles (S100); synthesizing metal-substituted metal oxide nanowires through hydrothermal synthesis of the metal-substituted metal oxide nanoparticles (S200); and obtaining a metal nitride and exsolved metal through ammonia treatment of the metal-substituted metal oxide nanowires (S300).

According to an embodiment of the present invention, the step of synthesizing metal-substituted metal oxide nanoparticles (S100) may be for synthesizing Ru-substituted TiO₂ nanoparticles.

According to an embodiment of the present invention, the step of synthesizing metal-substituted metal oxide nanowires through hydrothermal synthesis of the metal-substituted metal oxide nanoparticles (S200) may be for synthesizing Ru-substituted TiO₂ nanowires.

According to an embodiment of the present invention, the step of obtaining a metal nitride and exsolved metal through ammonia treatment of the metal-substituted metal oxide nanowires (S300) may be for obtaining TiN and Ru metal through a single step.

In an embodiment of the present invention, an exsolution method was used to fix metal nanoclusters to an inorganic support. In this embodiment, using this exsolution method, some of the noble metal components are embedded in the support, while others are induced to diffuse to the surface of the support, thereby fixing the metal nanoclusters more strongly to the inorganic support.

In addition, according to an embodiment of the present invention, a large number of anion defects are formed with the exsolution of metal nanoclusters, thereby forming a porous inorganic support with many crystal defects and improving mass and electron transfer characteristics, which results in improved electrocatalytic activity.

Additionally, according to an embodiment of the present invention, ammonia treatment of noble metal-substituted conductive metal oxide nanowires effectively stabilizes electrocatalytically active metal nanoclusters on the substrate by simultaneously exsolving the noble metal component and forming a porous nitride in a single step.

According to an embodiment of the present invention, in the step (S300) of obtaining a metal nitride and exsolved metal through ammonia treatment of the metal-substituted metal oxide nanowires, ammonia gas may be flowed at a flow rate in a range of 80 to 120 sccm. When heat treatment is performed with ammonia gas flowing at a rate lower than the lower limit of 80 sccm, there are cases where not all the O in TiO₂ is replaced with N, and some O remains.

According to an embodiment of the present invention, in the step (S300) of obtaining a metal nitride and exsolved metal through ammonia treatment of the metal-substituted metal oxide nanowires, the reaction may be carried out at a reaction temperature in a range of 700 to 900° C.

According to an embodiment of the present invention, in the step (S300) of obtaining a metal nitride and exsolved metal through ammonia treatment of the metal-substituted metal oxide nanowires, the reaction temperature may be reached at a temperature increase rate in a range of 100 to 300° C. per hour.

According to an embodiment of the present invention, in the step (S300) of obtaining a metal nitride and exsolved metal through ammonia treatment of the metal-substituted metal oxide nanowires, a metal nitride in the form of nanotubes may be obtained. In this case, the metal nitride in the form of nanotubes may have a porous surface.

According to another aspect of the present invention, there is provided a metal and metal nitride manufactured by the above manufacturing method, using a single-step nitridation-exsolution synthetic method.

Thus, the present inventors developed a new synthesis method that simultaneously achieves the exsolution process and the formation of a porous inorganic support with many crystal defects due to the large-scale formation of anion defects by ammonia treatment of noble metal-substituted metal oxides, and this method exsolved noble metal nanoclusters onto a porous conductive nitride support.

Although inserting noble metal nanoclusters into a porous conductive nitride support may be highly advantageous for optimizing the electrocatalytic activity of the resulting material through improved mass and electron transfer characteristics, there has been no technology to synthesize such materials in a single process to date.

In addition, while existing inventions involve complex additional synthesis steps, such as hybridizing precursors with other materials to improve the catalytic performance and stability of the material, the present invention easily enhanced electrocatalytic activity and stability through ammonia treatment.

Hereinafter, the present invention will be described in more detail through experimental examples. The following experimental examples are merely examples to help understanding of the present invention, and the scope of the present invention is not limited thereto.

### Experimental Examples

### 1. Synthesis of Ru-Substituted TiO2 Nanoparticles

Solution A: A quantitative ratio of RuCl₃·.xH₂O (Sigma-Aldrich) and 30 mL of isopropanol (Samchun Chemical Co., Ltd.) were added to a round bottom flask, and stirred for 30 minutes.
Solution B: 30 mL of isopropanol (Samchun Chemical Co., Ltd.) and a quantitative ratio of titanium isopropoxide (Sigma-Aldrich) were added to an Erlenmeyer flask.
Solution B was slowly added into Solution A. After adding all the solution, the pH was adjusted to 1.2 using nitric acid (Samchun Chemical Co., Ltd.) and the mixture was allowed to react at 85° C. for 8 hours. After the reaction, the solution was transferred to a Teflon-lined stainless autoclave and heated at 180° C. for 8 hours. After the reaction, the solution was sufficiently cooled and the precipitate was filtered out using a centrifuge. After washing away excess impurities with ethanol, the sample was dried in a 50° C. oven. Afterward, the dried sample was spread evenly in an alumina boat. The alumina boat was placed in a gas furnace, heat-treated in air at 500° C. for 3 hours, and then naturally cooled to room temperature to obtain ruthenium-substituted TiO₂ nanoparticles.

### 2. Synthesis of Ru-Substituted TiO₂ Nanowires

Ru-substituted TiO₂ nanoparticles and 50 mL of a 10 M NaOH solution were added to Teflon-

lined stainless autoclave and dispersed for 30 minutes using an ultrasonic device (JAC-3010). Afterward, the Teflon-lined stainless autoclave was placed in an oven and allowed to react at 200° C. for 12 hours. After the reaction, the solution was sufficiently cooled and the precipitate was filtered out using a centrifuge, and then washed thoroughly with 0.1 M HCl. Afterward, it was washed with distilled water until the pH reached 7. Subsequently, it was dried in a 50° C. oven to obtain Ru-substituted TiO₂ nanowires.

### 3. Single Nitridation and Ruthenium Metal Elution Method

The dried sample was spread evenly in an alumina boat. The alumina boat was placed in a gas furnace, NH₃ gas was flowed at a rate of 100 sccm, the sample was allowed to react at 900° C. for 3 hours at a temperature increase rate of 200° C. per hour, and then cooled naturally to room temperature.

### 4. Hydrogen Evolution Reaction (HER) Performance Evaluation

3.5 mg of the synthesized material and 1.5 mg of Vulcan XC-72 were dispersed in a solution of 2 mL of tertiary distilled water and 0.5 mL of isopropanol (KANTO). After adding 20 μL of a 5 wt % Nafion (Sigma-Aldrich) solution, the mixture was dispersed by sonication using an ultrasonic device (JAC-3010). 10 μL of the dispersed solution was taken and sampled on a glassy carbon (GC) rotating disk electrode (RDE) (ALS). An SCE electrode was used as a reference electrode, and a graphite rod was used as a counter electrode. The evaluation of hydrogen evolution reaction (HER) catalytic performance was conducted using an RRDE-3A rotating ring disk electrode apparatus (ALS) in a 0.5 M H₂SO₄ electrolyte purged with N₂ gas for over 30 minutes.

### Experimental Results

Hereinafter, the experimental results will be explained with reference to the drawings. For reference, the nomenclature of the synthesized materials is as follows.
RTO0-30=Materials synthesized from Ti1-xRuxO2 with x=0, 0.1, 0.2, and 0.3 (mol)
RTN0-30=Ammonia heat-treated samples of materials synthesized from Ti1-xRuO2 with x=0, 0.1, 0.2, and 0.3 (mol)

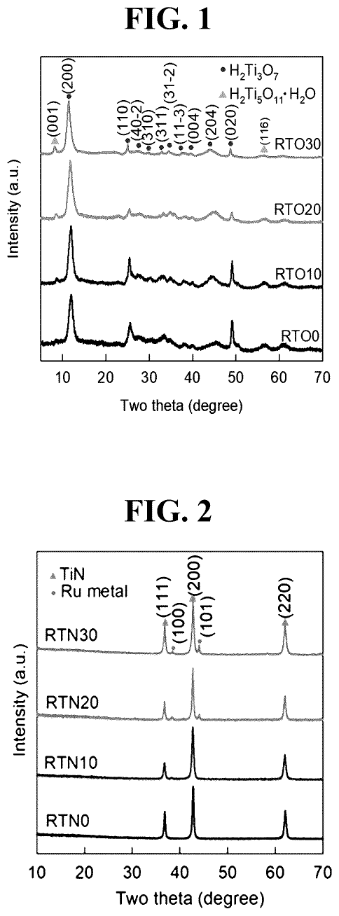

FIG. 1 shows the X-ray diffraction patterns of metal-substituted materials according to an embodiment of the present invention, and FIG. 2 shows the X-ray diffraction patterns of ammonia-treated materials according to an embodiment of the present invention.

Referring to FIG. 1, the Ti₁₋ₓRuₓO₂ material substituted with Ru showed typical Bragg reflections of the layered trititanate phase without impurity peaks. As Ru with a larger ionic size (0.62 Å) than Ti's ionic size (0.605 Å) was substituted, it was observed that the XRD peaks shifted to lower angles due to lattice expansion.

Referring to FIG. 2, heat treatment was performed to simultaneously carry out nitridation and ruthenium exsolution on the synthesized materials. By heat treatment with NH₃, oxygen ions were substituted with nitrogen ions, causing a phase transition from TiO₂ to TiN, while simultaneously exsolving Ru metal, which can be confirmed through FIG. 2. Samples with higher Ru content showed more distinct ruthenium metal peaks.

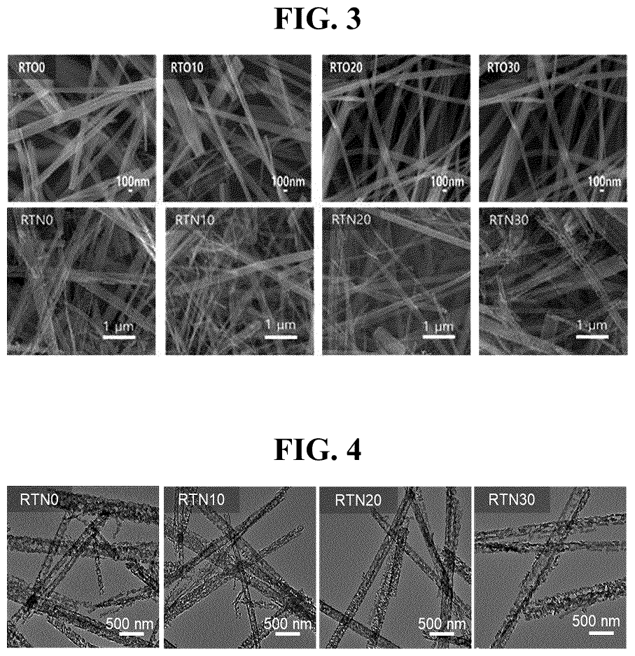

FIG. 3 shows scanning electron micrographs of metal-substituted materials and ammonia-treated materials according to an embodiment of the present invention, and FIG. 4 shows transmission electron micrographs of ammonia-treated materials according to an embodiment of the present invention.

Referring to FIG. 3, it can be seen that RTO0-20 has the typical shape of TiO₂ nanowires. Referring to FIG. 4, it was confirmed that after heat treatment, the shape of the sample RTN0-20 was changed into nanotubes and simultaneously pores were formed on the surface. Through the TEM images in FIG. 4, it was confirmed that pores were formed on the sample surface after heat treatment.

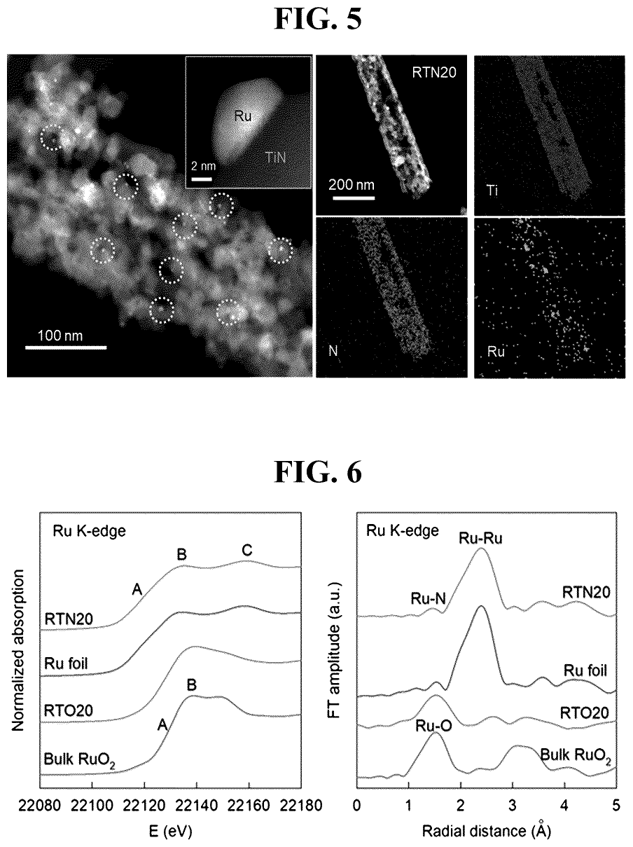

FIG. 5 shows scanning transmission electron micrographs and elemental mapping of ammonia-treated RTN20 according to an embodiment of the present invention.

FIG. 5 shows scanning transmission electron micrographs and energy dispersive X-ray spectroscopy (EDS) data for RTN20. The elemental mapping results for Ti, N, and Ru reveal that Ru is evenly distributed throughout the nanotubes composed of Ti and N, with a size of approximately 4 nm. In addition, it can be seen that Ru is embedded in the surface of the TiN nanotubes.

FIG. 6 shows (a) X-ray absorption near edge structure (XANES) and (b) extended X-ray absorption fine structure (EXAFS) of materials synthesized according to an embodiment of the present invention.

Referring to FIG. 6, XANES and EXAFS analyses were performed to confirm the crystal structure of the synthesized materials.

Referring to FIG. 6A, in the case of RTO20, which is the material before heat treatment, it can be seen that Ru is present in a tetravalent oxidation state as its absorption edge position is identical to the absorption edge position of RuO₂. After heat treatment, the peak is positioned at a lower energy than RuO₂, indicating that Ru has been reduced. In particular, the fact that the absorption edge peak position is identical to that of Ru foil suggests that Ru has been reduced to a zero-valent state.

Referring to FIG. 6B, after heat treatment, the largest peak appears around 2.4 Å, and its similarity to the FT spectrum of Ru foil indicates that the substituted Ru has been exsolved as Ru metal.

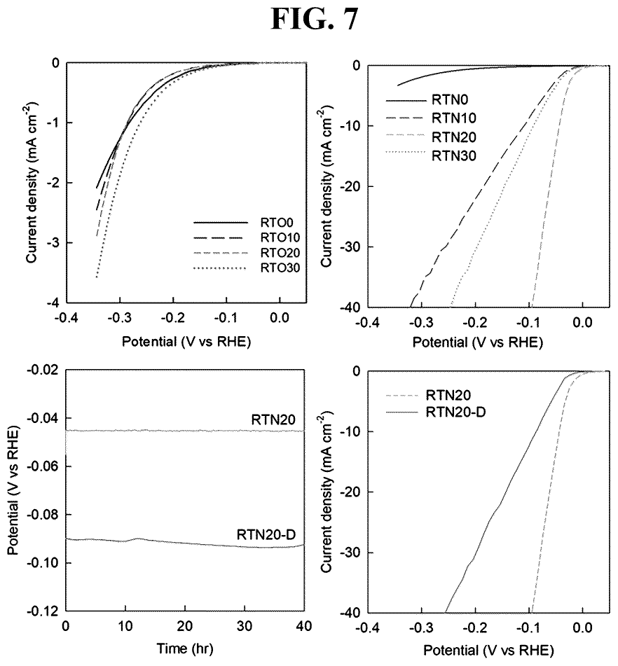

FIG. 7 shows hydrogen evolution reaction (HER) activity data of materials synthesized according to an embodiment of the present invention. All materials were measured in a 0.5 M H₂SO₄ solution at a scan rate of 5 mV/s.

Referring to FIG. 7, overall, the samples with exsolved Ru after heat treatment (RTN10-30) showed higher HER activity than the materials before heat treatment (RTO0-30), and showed improved onset potential and over potential. In addition, materials including Ru (RTN10-30) showed better performance than materials without Ru (RTN0). Through this, it can be confirmed that the HER performance was enhanced due to the synergy of Ru metal exsolution. In addition, the HER performance was improved as the Ru content increased. However, the performance of RTN30 was actually lower, indicating that there is an optimal condition for ruthenium substitution. Furthermore, when compared to materials with Ru nanoclusters deposited on the surface (RTN20-D), it was confirmed that the exsolved samples (RTN20) showed better performance along with excellent stability. Through this, it was confirmed that the method of manufacturing a metal and metal nitride using a single-step nitridation-exsolution synthetic method contributes to catalytic performance and stability.

The present invention has been described with reference to preferred embodiments, but those skilled in the art will understand that various modifications and changes can be made to the invention without departing from the spirit and scope of the present invention as defined in the following claims.

1. A method of manufacturing a metal and metal nitride using a single-step nitridation- exsolution synthetic method, the method comprising:
synthesizing metal-substituted metal oxide nanoparticles (S100);
synthesizing metal-substituted metal oxide nanowires through hydrothermal synthesis of the metal-substituted metal oxide nanoparticles (S200); and
obtaining a metal nitride and exsolved metal through ammonia treatment of the metal- substituted metal oxide nanowires (S300).

2. The method of claim 1, wherein in the step (S300) of obtaining a metal nitride and exsolved metal through ammonia treatment of the metal-substituted metal oxide nanowires, ammonia gas is flowed at a flow rate in a range of 80 to 120 sccm.

3. The method of claim 1, wherein in the step (S300) of obtaining a metal nitride and exsolved metal through ammonia treatment of the metal-substituted metal oxide nanowires, the reaction is carried out at a reaction temperature in a range of 700 to 900° C.

4. The method of claim 3, wherein in the step (S300) of obtaining a metal nitride and exsolved metal through ammonia treatment of the metal-substituted metal oxide nanowires, the reaction temperature is reached at a temperature increase rate in a range of 100 to 300° C. per hour.

5. The method of claim 1, wherein in the step (S300) of obtaining a metal nitride and exsolved metal through ammonia treatment of the metal-substituted metal oxide nanowires, a metal nitride in the form of nanotubes is obtained.

6. The method of claim 5, wherein the metal nitride in the form of nanotubes has a porous surface.

7. A metal and metal nitride manufactured by the method of claim 1, using a single-step nitridation-exsolution synthetic method.
